(19) United States
(12) Patent Application Publication
(10) Pub. No.: US 2016/0277360 A1
(43) Pub. Date: Sep. 22, 2016

(54) Dynamic Data Exfiltration Prevention Process (DDEPP)

(71) Applicants: John B. Dwyier, Chantilly, VA (US); Glen David Gulyas, Arlington, VA (US); Joseph Lawn, Arlington, VA (US); David Frank Russo, Davidsonville, MD (US)

(72) Inventors: John B. Dwyier, Chantilly, VA (US); Glen David Gulyas, Arlington, VA (US); Joseph Lawn, Arlington, VA (US); David Frank Russo, Davidsonville, MD (US)

(73) Assignee: Migrate2, LLC

(21) Appl. No.: 14/664,051

(22) Filed: Mar. 20, 2015

(51) Int. Cl. H04L 29/06

(52) U.S. Cl. CPC H04L 63/04

(57) ABSTRACT

This patent application contains the details for a dynamic data exfiltration prevention process. It includes the field of invention, what the invention is, examples of current works in the field, a summary of the invention, brief and detailed descriptions, and a claim statement. Numerous diagrams are included in the brief descriptions section to aid in understanding. The processes used to build, setup, and operate the invention are detailed to show that we have built an entirely new process that will become a standard part of defense in depth for the cyber security industry.

### CROSS REFERENCE TO PROVISIONAL PATENT

U.S. Pat. No. 6,196,8814

Filing Date: Mar. 21, 2014

### BACKGROUND

1. Field of the Invention: Electronic Data Security

DDEPP is a process that provides pro-active, real-time, live monitoring and control of data flows to prevent exfiltration of critical data from the enterprise or cloud.

The present invention is directed toward protecting sensitive electronic data in real-time by programming data protection policies, examining organizational and user behavior, and continuously monitoring network data flows by live personnel to prevent exfiltration from the enterprise or cloud to other parties, whether by accident, through negligence, or as a malicious act.

2. Description of the Related Art

Important forms of electronic data security include the use and monitoring of firewalls, intrusion detection and protection systems, anti-virus software, and various business continuity products, mechanisms, and processes.
Firewalls and related processes are usually aimed at preventing direct intrusion by external parties to the network.
Intrusion detection and protection software tries to detect and/or remove external parties once they have passed the firewall and obtained network access.
Anti-virus software and related processes are directed at avoiding malicious software that can steal, damage, or destroy network data.
Business continuity products and processes are used to mitigate damage done to the operating systems, network and stored data as well as to restore system operability after an operating system failure or data exfiltration.

### SUMMARY

First objective: To survey client system architecture, network topology, data stores, workflow, data flows, other security features, and written security policies to establish the current baseline security posture and properly define and implement a specific data exfiltration prevention plan.

Second objective: To continuously monitor the application of the data exfiltration prevention policy and other network data in real-time and use the resulting analysis to enhance the data exfiltration prevention and general security posture of the organization.

Third objective: To react in real-time to attempts to exfiltrate sensitive data from the network.

Fourth objective: To collect and analyze data exfiltration prevention policy metrics and network data to find patterns of exfiltration attempts, and to collect and analyze other relevant user and network behaviors to find patterns, and then incorporate the results of these analyses in iteratively improving the data exfiltration prevention process for the network.

### BRIEF DESCRIPTIONS

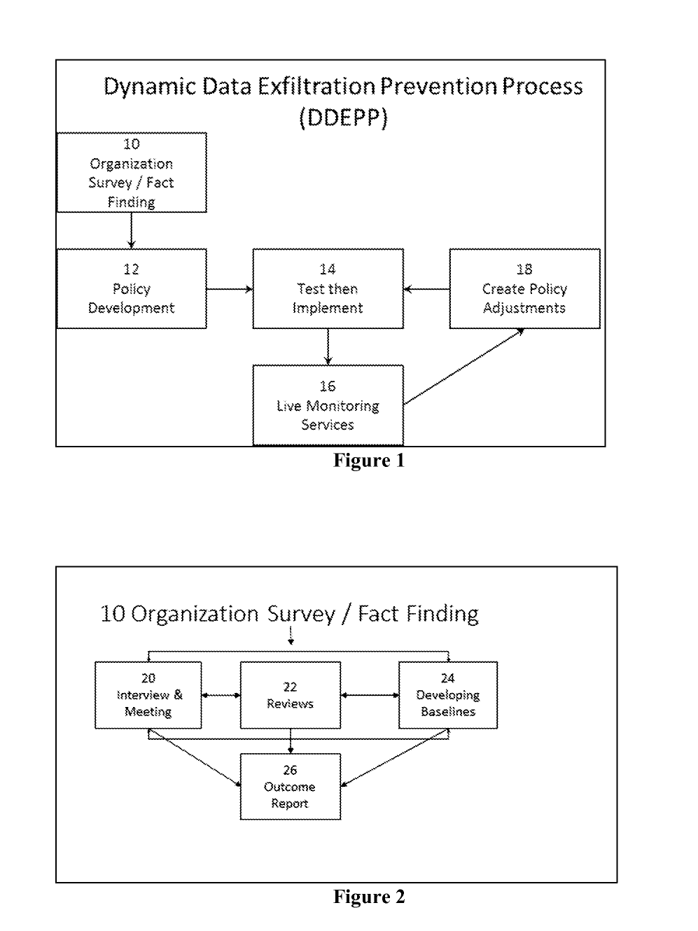

### FIG. 1

[10] Organization Survey/Fact Finding: DDEPP is an iterative process that begins with an initial analysis of the target organizations data, network, policies, and business plans.

[12] Policy Development: After analyzing the data from the Discovery phase, DDEPP personnel establish an initial data exfiltration policy with rules that can either permit the free flow of data from the network without further notice.

[14] Test, then Implement: Before full implementation, the basic data exfiltration prevention policy designed by the DDEPP team must be tested in a way that will not interrupt or interfere with network operations.

[16] Live Monitoring Services: After implementation is complete, DDEPP provides for real-time, continuous monitoring by live personnel.

[18] Create Policy Adjustments: (and other appropriate actions). From these analyses, the DDEPP team designs appropriate data exfiltration prevention policy adjustments to accommodate the information gained.

### FIG. 2

[10] Organization Survey and Fact Finding Includes:

[20] interviews with key personnel concerning site surveys, system architecture, network topology, security apparatus, and data in storage and in motion during normal workflow.

The DDEPP team will conduct [22] reviews of written security policies and compliance thereof and network flow and volume data.

The DDEPP team will develop [24] baselines for security compliance, network data volume, internal data access traits, and external communication habits.

[26] Outcome report is presented with guidelines for security policy development.

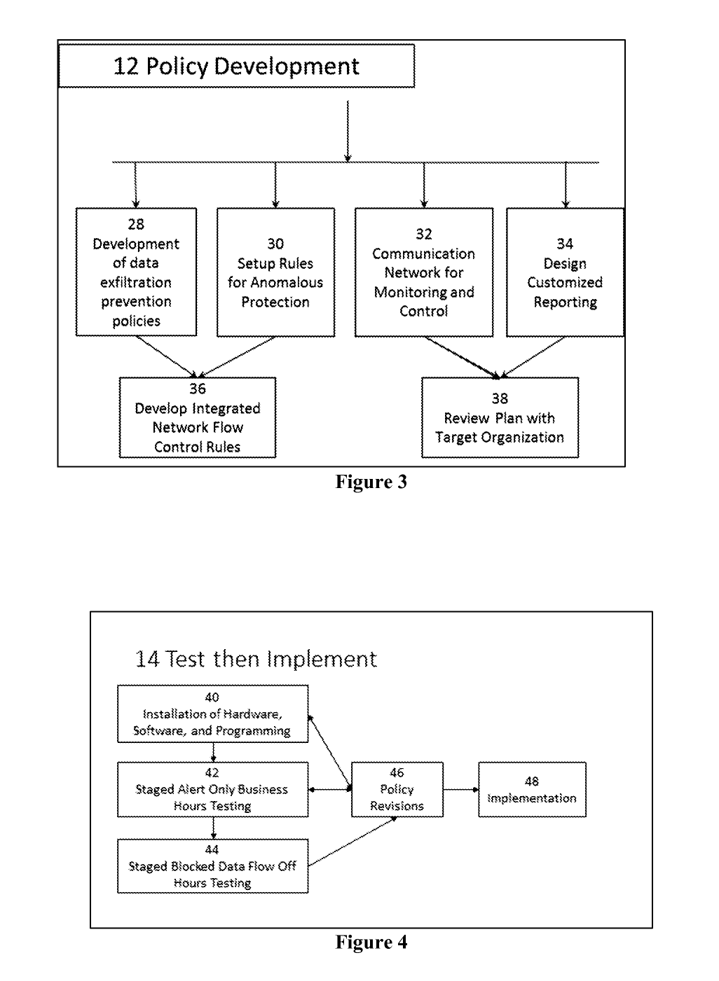

### FIG. 3

### [12 Policy Development Includes:

[28] Data exfiltration selection. Sensitive data to be protected is selected and processed. Local data stores are searched for additional copies of the sensitive data. Rules are developed for data exfiltration prevention policy.

The DDEPP team will develop [30] anomalous data usage behavior protection rules based on deviation allowable from the baseline volume, flow, and timing of access and communications.

The DDEPP team will design and setup secure layer two [32] communications networks for monitoring and control.

The DDEPP team will select custom [34] reporting from the subset of standard reports and custom analysis.

The DDEPP team will [36] develop integrated rule sets between the disparate data exfiltration prevention and anomalous protection system that will control network flow and enhance protection by stopping suspect data leakage.

The DDEPP team will [38] review rules, plans, and procedures with the organization.

### FIG. 4

[14] Test then Implement Includes:

[40] The installation phase can include the installation and programming of hardware, software, networking equipment, and communication equipment. Data exfiltration prevention security policies will be applied to the equipment and software.

The DDEPP team will initially [42] test the data exfiltration prevention software policies during business hours to accommodate receiving appropriate test data. This phase will include only data logging without any network controls being applied then policy revision.

[44] Initial data exfiltration prevention deployment with network controls applied will be off business hours with network controls engaged followed by [46] policy revision.

[48] Once the policy revision phase is completed, implementation is achieved and monitoring services can commence.

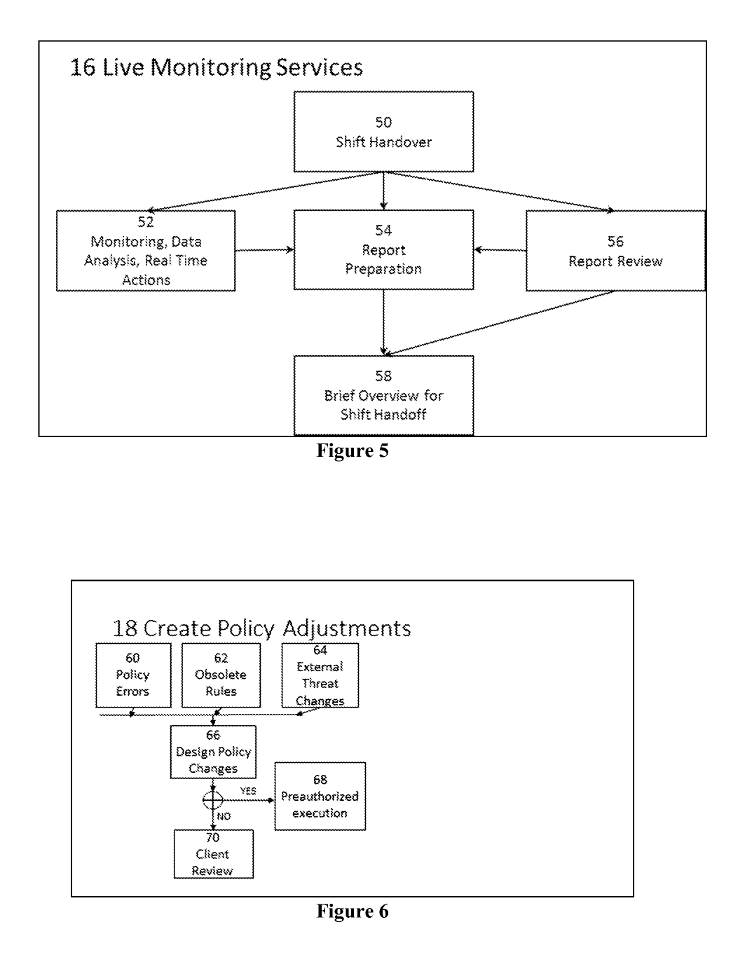

### FIG. 5

### [16] Live Monitoring Services Includes:

[16] Live monitoring of data exfiltration prevention services, network traffic volume, data flow metrics, communication endpoint security, and anomalous detected incidents will occur. The live monitoring will run constantly and in perpetuity in overlapping shifts.

[50] Overlapping shifts allow for briefings of incoming monitoring personnel.

[52] During each shift, the DDEPP team's work will include monitoring for security incidents as defined by the data exfiltration prevention system. This will include data in motion, data at rest, incidents, usage metrics and anomalies, exfiltration attempts, and behavioral statistics.

[54] Shift reports will be generated at the end of each shift with the report being prepared by the monitor.

[56] Reports will be reviewed in each step up the line, the end of each shift, daily, weekly, monthly.

The DDEPP team member leaving at the end of his/her shift will [58] brief the incoming staff before leaving during overlapping time.

### FIG. 6

### [18] Create Policy Adjustments Includes:

The DDEPP team will follow this process to [18] create policy adjustments working in conjunction with organizational contacts.

The team will adjust [60] policies in error in design. Those not in congruence with written policies, or not correctly functioning will be corrected through adjustment mechanism procedures.

[62] Policies that become obsolete from changes in written security policies or changes in protected data status will be corrected through adjustment procedures.

[64] Policies that require change due to external threat changes will be corrected through adjustment procedures.

[66] The team will design policy changes and produce them in writing.

[68] Policies that fall into the category of those that are pre-authorized because they are both urgent and relatively-minor will be made immediately by monitoring staff or supervisory personnel.

[70] Final Review with client. Policy changes that are not pre-authorized will be reviewed by supervisory personnel working with organizational contacts and implemented upon approval of the client.

### DETAILED DESCRIPTION

DDEPP is a process that provides pro-active, real-time monitoring of data flows to prevent exfiltration of critical data from the enterprise. DDEPP personnel monitor data flows and policy violation incidents in real time to determine whether or not attempts are being made to breach confidentiality from the target network and stop the copying or removal to another foreign data repository.

DDEPP makes use of one or more proprietary technologies to gather the necessary raw data by which to make these determinations. The service requires, at a minimum, a data exfiltration examination technology that can flag and control policy violations and data events in real time and a secure communications connection to the monitoring center. DDEPP also makes use of technology that measures certain baseline network activities per user to measure changes in user behavior over time to discover other potential breaches of data in real-time through anomalous means. Optionally, the service can be used to enhance security through the use of secured end point communications between the users and the enterprise.

The data exfiltration prevention technology examines all outbound data flow and compares it with security policies in real time and stops data flow that violate tenets of the enterprise's data exfiltration prevention policy. DDEPP relies on rule-based data exfiltration prevention security policies that define permitted and forbidden data flows and performs checks against a database that singularly identifies all critical data within the enterprise. In addition outbound data flow is checked against pattern matching engines, specific application usage, destination filters, and other custom rule sets. An example of a data flow rule is to forbid the transmission of Social Security Numbers out of the network, whether by file transfer, inclusion in e-mail, or other method.

The data exfiltration prevention technology also generates real-time results of security policy violations, allowed but flagged data flows, and other data to monitoring personal to enhance the performance of the service.

Continual adjustments to policy by monitoring personnel are used to balance between having too many false positives, thereby impeding genuine workflow, or too loose a data policy that does not catch enough of the outbound policy violations. DDEPP is a process of continuously monitoring and fine-tuning the data exfiltration prevention technology real time to minimize both possibilities and thus significantly enhance the utility of the combined technologies.

Another critical technology for DDEPP is that which collects individual user data in real-time and maintains attributes of behavior for use as a baseline of usual activity that can be checked for anomalous deviations from the norm and either alert monitoring staff for closer examination or stop the data flow depending on client needs. By creating a baseline of each user's data usage and data flow metrics our technology monitors for anomalies and can alert monitoring staff or stop the flow of data until the activity is cleared. By continuously comparing current data usage and data flow metrics to the expected baseline, DDEPP can identify potential breaches for the technologies or the monitoring personnel to act in real-time rather than long after the fact.

### Detailed Walk-Through of the Steps in DDEPP:

### [10] Organization Survey and Fact Finding

The four primary activities of this phase include the following. The first three activities run in parallel, the fourth is the outcome of the first three:

[20] Interviews and Meetings

The DDEPP team meets with representatives of the various stakeholders in the organization, including senior management, senior IT management, network administrators, project managers, and end users. A purpose of these interviews and meetings is to develop a narrative of how data is used in the enterprise. Information discovered includes the identification of sensitive data in the enterprise, the general rules of use of sensitive data, who may send specific sensitive data out of the enterprise, to whom, and in what quantities. Other important information to be discovered and developed includes data workflow, especially of sensitive data, anticipated data use by time, by place, by user, and by group. In conjunction with reviews of appropriate documents, the DDEPP team meets with IT administrators to go over written network configurations, network security policies, enforcement mechanisms, and network and security processes currently in force within the organization.

[22] Reviews of Enterprise System and Security Documents

The DDEPP team performs its own Site Survey and reviews that in addition to what is provided by the organization, written computer system documents, network configurations, security policies and procedures, business continuity plans, ISP details, network and e-mail usage policies, employee manuals, and any other relevant material.

[24] Development of Baselines

Concurrent to the first two activities, the DDEPP team employs technologies that track critical data use by user and by group and data flow metrics. It is here that collection of the raw data is started for later use in the anomalous behavioral analysis processes to discover deeper patterns in relation to increasing the abilities covered under our data protection and exfiltration prevention. Tracking is used to discover data volume, timing, and frequency metrics to determine whether data use is congruent to the narrative described by the organization's stakeholders to the DDEPP team, especially regarding compliance with network and security policies, workflow of data, use of sensitive data, and exfiltration of sensitive data, by user and by group. Once data metrics are aligned with stakeholders' narrative and agreed upon, the expectations for both sides can be properly formed. From this data, baselines are then developed, including creation of individualized data sets that track departure from normative behavior through setting of individualized statistical parameters. In this process, the DDEPP team creates a programmable anomalous data exfiltration filter. Policy is developed with the organization to adjust the levels of sensitivity of abnormal data use behavior per user.

[26] Creation of Outcome Report

The Outcome Report describes in detail the findings from the previous three activities, and is used as a guide in the development of the organization's DDEPP policy.

### [12] Policy Development

After analyzing the data from the Discovery phase, DDEPP personnel establish an initial data exfiltration policy with rules that can either permit the free flow of data from the network without further notice; permit the free flow of data from the network, but in some way alert or notify the monitoring team and/or other parties; or block data from leaving the network.

[28] Development of Data Exfiltration Prevention Policies

The DDEPP team uses appropriate technologies to design and develop a data exfiltration prevention policy using various tools. These tools include critical data fingerprinting, creation of data vaults, data duplication searches, scheduled events, and rule sets to prohibit the exfiltration data though fingerprint comparisons, dictionary-based rule sets, pattern matching and other filtering methods. Data inspection is done by deep packet inspection. Technologies may include comparison based testing of outbound data and analysis of data metrics for anomalous comparisons.

The DDEPP team uses data exfiltration prevention technology that can inspect data flow at the packet level for actual data comparison as well as patterns of data and compare these at line speed to the data and patterns stored in our database. This includes fully-identified and fingerprinted critical data and standard or custom made pattern analysis algorithms as well.

Using this technology, and the results from the Outcome Report, the DDEPP develops the Data exfiltration prevention policy to produce real-time alerts or blocks, with or without notification, as users attempt to send previously-identified sensitive data outside of the organization. This policy prevention technique is automated, monitored, and functions in real-time.

[30] Development of Behavioral Analysis Policies

From the baseline studies, the DDEPP team develops policies that when implemented produce real-time alerts, and blocks, with or without notification, of deviations from the identified norms of user and group data usage. From previous meetings with key organizational staff, the DDEPP team will implement the desired levels of sensitivity to abnormal usage patterns.

[32] Development of Secure Communications Network

Through the use of appropriate technologies, the DDEPP team will design and implement an OSI layer two secure network with previously paired fully secure endpoints.

[34] Report Design

The DDEPP system provides a standard set of reports; including the shift log (which documents issues related to alerts, blockings, usage, and availability), the daily report (which is a compilation of shift logs), the weekly report, the monthly and the quarterly reports. Each of these reports can provide information on both data exfiltration prevention, and user and group data usage behavior. Reports will be tailored to the specific requirements of the organization, covering only those data sets actually monitored for the organization, and at the level of sensitivity desired by the organization.

[36] Develop Integrated Rule Sets

The DDEPP team will examine in detail the rule sets comprising the policies for both data exfiltration prevention and user data usage behavioral analysis, to assure consistency between the two rule sets and to avoid conflicts between them.

[38] Review Rules, Plans, Procedures and Policies with the Organization

[14] Test, then Implement

[40] Installation of Hardware, Software, and programming

The installation phase can include the installation and programming of hardware, software, networking equipment, and communication equipment. Data exfiltration prevention security policies will be applied to the equipment and software.

[42] Staged Testing: Alert-Only During Business Hours.

Data exfiltration prevention software policies will be tested initially within business hours to accommodate receiving appropriate test data. This phase will include only data logging without any network controls being applied then policy revision.

[44] Policy Revisions

As initial testing is performed and analyzed, the DDEPP team makes appropriate revisions as the team observes how the policies work in the actual organizational data environment. This is an iterative process

[46] Staged Testing: With Blocking, Outside of Business Hours

As the team develops increased confidence that the policy rules will not obstruct network operations inappropriately, the team moves to the second phase of testing, which is to turn on data exfiltration blocking, but initially testing only outside of business hours. With lower levels of use and traffic, problems that occur will likely be on a smaller scale than if full implementation had been during business hours. The DDEPP team monitors the results and revises the policies as needed, as problems arise from full implementation. This process is iterative.

As testing proceeds and problems and issues are identified, the team returns to [44] policy revisions until the team cannot identify further problems.

[48] Implementation

Once the policy revision phase is complete, the team can fully implement the data exfiltration prevention process, with alerts and exfiltration blocking, as designed, and monitoring services can commence.

Once the DDEPP team is confident that testing has uncovered any problems with the policies, the team reviews the results with the organization senior management and select stakeholders, makes any final revisions based on this review, and then implements the full policies during business hours.

At this point, actual blocking of attempted, inappropriate data exfiltration will be in place.

### [16] Live Monitoring Services

After implementation is complete, DDEPP provides for real-time, continuous monitoring by live personnel, ideally on a 24/7/365 basis (although some organizations may choose less comprehensive monitoring schedules).
The monitoring team performs several tasks during each shift.

[50] Shift Handover

Each shift begins with a shift handover, where the outgoing monitoring team member will provide the previous shift log to the incoming team member, and will orally communicate any important information required, including at least a summary of red and yellow incidents, and any noticeable data usage trends to watch.

[52] Monitoring, Analysis, and Real-Time Actions

The team member will take appropriate actions related to real-time network events and incidents, including notifying organizational personnel of the attempted breach, adjusting the policy in real-time where there has been an unintended result, identifying in real-time a specific workstation within the network being used for attempted infiltration, to enable identifying physically the actual workstation user, in extreme cases, recommending to network and organizational senior personnel the complete, temporary shutdown of the network, or sections thereof to prevent further attempts at data exfiltration;

The team member will also perform analysis on data reported on his/her shift and previous shifts including but not limited to:
Data Analysis for Additional Investigation, which is searching for patterns in red and yellow events that can suggest a need for further investigation of user data usage;
Data Analysis to Identify Changing Data in Motion Requirements which is searching for patterns in incidents and attempted exfiltration events that can suggest the need to modify the data exfiltration prevention policy and the data usage policies to account for changing requirements from within the organization;
Data Analysis to Identify Changing Data Usage

Behavior, which is searching for behavioral patterns of user network use by identifying changes from baseline measures of user data transfer volumes, user usage times, user data access or access attempts, user location on the network, as determined by IP address, machine or device name, and/or network login;
New and Changing External Threats which is identifying new and emerging threats from outside the organization's environment and adjusting the data exfiltration prevention policy to meet these new challenges.

[54] Report Preparation

The team member on duty will prepare shift log reports, collate shift logs into daily reports, daily reports into weekly reports, and weekly reports into monthly report.

[56] Report Review

Shift reports will be compiled into daily reports and reviewed by a supervisor to be sent to the clients.

[58] Shift Handoff.

At the end of the shift, the outgoing team member will perform a shift handover to the incoming team member.

### [18] Create Policy Adjustments

Creation of Policy Adjustments and other appropriate actions: From constant monitoring and analyses the DDEPP team designs appropriate data exfiltration prevention policy adjustments to further pursue data security and still accommodate the needs of organization. These adjustments can include loosening or tightening data transfer rules for individuals or groups, to accommodate changes in organizational workflow or data stores, or to “plug” possible leaks of data. The programmable anomalous data exfiltration filter can identify specific individuals or groups of individuals who may be misusing access rights for exfiltration of selected sensitive data, or otherwise acting in ways that cause concern and require either increased monitoring or other action.

[60] Policy Errors

Through continuous monitoring, DDEPP team members will identify errors in policy rules that cause false positives or false negatives for both violations and critical incidents, and will propose recommended fixes thereto.

[62] Obsolete Rules

As the organization changes, so will its possession and use of data, and policy rules may become obsolete over time. Accompanying written policies may change with review forcing changes in exfiltration policies. DDEPP team members will identify these problems and propose appropriate changes.

[64] External Threat Changes

As new external threats change and emerge, the DDEPP team will pro-actively work to discover them and propose policy rule changes to meet the emerging threats and other changes in the external environment.

[66] Designing Policy Changes

The team will design policy changes and produce them in writing. Proposed changes to policy rules will be documented in writing, tested in alert-only mode during business hours, then fully during off-hours, and then fully-implemented during business hours, after testing is complete and the proposed change is reviewed with the client. Changes will be either pre-approved or reviewed by the client before implementation.

[68] Immediate Rule Changes

Where policy rules create an immediate, significant problem for end-users, and where the rule changes are minor, the DDEPP team member on duty may change the rule without prior review and approval. The simplest fix may be to produce a new rule that doesn't block data exfiltration, but only creates an alert, but with enhanced monitoring. Pre-approval agreements will exist that define what can and can't be changed without prior approval.

[70] Final Review with Client

Policy rule changes that are not immediately implemented will be reviewed with key personnel of the client organization. The client will be presented the written results of rule change testing, and full implementation will occur after final client approval.

### PREFERRED EMBODIMENT

The preferred embodiment comprises a minimum of five monitoring team personnel to provide 24/7/365 continuous monitoring coverage. Other embodiments may require less monitoring than round-the-clock. To provide round-the-clock protection, the monitoring team includes a Team Supervisor, a second-in-command Team Leader, and three Team Analysts. The method followed by the monitoring personnel is previously described.

Any embodiment must include, but is not limited to, data exfiltration prevention technology and secure network endpoint technology for command and control, and monitoring. DDEPP occurs only if the process can identify and prevent threats in an automated way and report the findings to the monitoring team. Other technologies included in the preferred embodiment include programmable anomalous data exfiltration filter which measures network and data usage by user, noting important characteristics such as IP address, machine name, and other personal and location-identifying information and adding it to the baseline for the user for future analysis.

What is claimed is:

1) A method that provides data confidentiality through a data exfiltration prevention system that responds in real-time to efforts or potential efforts to exfiltrate sensitive data through the process of monitoring by both human personnel and technologies that dynamically employ a control method of signature exfiltration filters and statistical anomaly-based detection filters via secured network communications.
